(19) United States
(12) Patent Application Publication
(10) Pub. No.: US 2018/0183051 A1
(43) Pub. Date: Jun. 28, 2018

(54) COMPOSITE MATERIAL COMPRISING CARBON NANO-OBJECTS, PROCESS FOR PREPARING SAME, AND INK AND ELECTRODE COMPRISING THIS MATERIAL

(71) Applicant: COMMISSARIAT A L'ENERGIE ATOMIQUE ET AUX ENERGIES ALTERNATIVES, Paris (FR)

(72) Inventor: Pascal TIQUET, Grenoble (FR)

(73) Assignee: COMMISSARIAT A L'ENERGIE ATOMIQUE ET AUX ENERGIES ALTERNATIVES, Paris (FR)

(21) Appl. No.: 15/128,779

(22) PCT Filed: Mar. 23, 2015
(86) PCT No.: PCT/EP2015/056143

§ 371 Date: Sep. 23, 2016

(30) Foreign Application Priority Data
Mar. 24, 2014 (FR) 1452457

(51) Int. Cl. H01M 4/36; C09D 11/52; C09D 11/037; C09D 5/24; C09D 7/62; C09D 7/40; C01B 32/174; H01M 4/38; H01M 4/587; H01M 10/0525

(52) U.S. Cl. CPC H01M 4/364; C09D 11/52; C09D 11/037; C09D 5/24; C09D 7/62; B82Y 30/00; C09D 7/68; C01B 32/174; H01M 4/386; H01M 4/587; H01M 10/0525; C09D 7/67

(57) ABSTRACT

Composite material comprising nano-objects made of at least one first electron conducting material and nano-objects or submicron objects made of at least one second material differing from the first material; said composite material comprising nanostructures each consisting of the nano-objects made of at least one first electron conducting material marked with a first molecule, the nano-objects or submicron objects made of at least one second material differing from the first material being marked with a second molecule and being self-assembled and attached onto the nano-objects made of at least one first material by specific recognition between the first molecule and the second molecule, said nanostructures being homogeneously distributed in the material, the nano-objects made of at least one first electron conducting material being selected from among carbon nanotubes and carbon fibres, and the nano-objects or submicron objects made of at least one second material differing from the first material being selected from among silicon nanoparticles and submicron silicon particles.

Process to prepare said nanocomposite material.

Ink comprising said composite material.

Electrode comprising said composite material as electrochemically active material.

Electrochemical system in particular a lithium ion storage battery comprising said electrode.

### TECHNICAL FIELD

The invention concerns a composite material comprising carbon nano-objects. The material of the invention could therefore also be called a nanocomposite material.

More specifically, the invention concerns a composite material comprising Carbon NanoTubes (CNTs) or carbon nanofibres and silicon nanoparticles or submicron silicon particles.

The invention also concerns a process to prepare said composite material.

The invention further relates to an ink comprising the composite material of the invention.

The composite material of the invention which is a composite silicon/carbon material can be used in particular, optionally after carbonisation, as electrochemically active electrode material, particularly as electrochemically active negative electrode material, in non-aqueous, organic electrolyte electrochemical systems such as rechargeable electrochemical storage batteries with organic electrolyte, notably in lithium batteries and more specifically in lithium ion batteries.

The invention is therefore also directed towards an electrode, in particular a negative electrode, comprising this composite material, carbonised, as electrochemically active material.

The invention also concerns an electrochemical system e.g. a lithium ion storage battery comprising said electrodes.

The technical field of the invention can be generally defined as that of composite materials comprising carbon and another material such as silicon.

### STATE OF THE PRIOR ART

The growth of the mobile electronics market has allowed the emergence of lithium rechargeable battery technology; and consequently the specifications for equipment using such rechargeable batteries have come to contain increasingly tighter restrictions. This equipment requires ever more power and battery life whilst a reduction in the volume and weight of rechargeable batteries is also sought after.

Lithium technology offers the best characteristics compared with other available technologies. The element lithium is the most lightweight and best reducing metal, and electrochemical systems using lithium technology can reach voltages of 4V compared with 1.5V for other systems.

Lithium ion batteries offer a mass-specific energy density of 200 Wh/kg versus 100 Wh/kg for NiMH technology, 30 Wh/kg for lead and 50 Wh/kg for NiCd.

However, current materials and in particular active electrode materials are reaching their limits in terms of performances.

These active electrode materials are composed of an electrochemically active material which forms a receiving structure in which cations e.g. lithium cations are inserted and deinserted over the course of cycling. The negative electrode material the most frequently used in lithium ion batteries is graphite carbon, but its reversible capacity is low and it exhibits irreversible capacity loss [symbol] ICL [symbol] .

Carbon nanotubes have been used as additives for active electrode materials whether negative or positive, or as active anode material for the purpose of improving the performance of lithium ion batteries.

For example, document [1], LIU et al., «Carbon nanotube (CNT)-based composites as electrode material for rechargeable Li-ion batteries: A review», Composites Science and Technology, 72 (2012), 121-144, describes nanocomposite materials comprising single-wall carbon nanotubes and various cathode materials such as LiCoO₂, LiFePO₄, LiMn₂O₄, or intrinsically conductive polymers.

This document also indicates that carbon nanotubes can be used as anode material instead of graphite, and describes nanocomposite anode materials comprising single-wall carbon nanotubes and various active anode materials such as Sn; Bi; SnSb; CoSb₃; Ag, Fe and Sn; TiO₂; SnO₂; Li₄Ti₅O₁₂; oxides of transition metals such as TiO₂, CO₃O₄, CoO and Fe₃O₄; and finally silicon.

Rechargeable batteries which use the materials listed in document [1] still perform insufficiently.

Also, it is known that with regard to active materials for negative electrodes in the Li/ion industry, one possible way of improving the performance thereof is to replace graphite by another material having better capacity, such as tin or silicon.

Having an estimated theoretic capacity of 3579 mAh/g (for Si→Li_{3,75}Si), silicon is a desirable alternative to carbon as negative electrode material. Nonetheless this material has a major disadvantage which prevents use thereof. The volume expansion of silicon particles which can reach up to 400% when being charged during lithiation (Li-ion system) leads to degradation of the material with fissuring of particles and their detachment from the current collector.

This weakening of the material is currently difficult to control and leads to low electrode cyclability.

It has been shown that the use of these materials such as silicon in the form of nanometric powders can allow limiting of the magnitude of these degradation phenomena and allows improved reversibility to be obtained for capacities close to theoretical values.

However, the use of nanometric silicon powders is rapidly confronted with problems relating to maintained electron percolation within the electrode.

To provide a material capable of maintaining electrode integrity after repeated charging-discharging cycles and to overcome the problems inherent in silicon, much research has therefore focused for several years on materials in which the alternative material such as silicon is paired with carbon: these mostly concern composite silicon/carbon materials in which silicon is generally dispersed in a carbon matrix.

The purpose of these materials is to combine the good cyclability of carbon with the provision of additional capacity due to the addition of silicon.

However, batteries such as lithium ion batteries which comprise such materials still display, here again, an insufficient performance level.

Document CN-A-101439972 [2] describes particles of composite silicon-carbon material comprising carbon nanotubes attached to silicon nanoparticles via amorphous carbon.

This composite material is prepared using a process comprising the following successive steps:
the silicon nanoparticles and carbon nanotubes are dispersed in a solvent such as water or ethanol in the presence of a dispersing agent;
the solvent and dispersing agent are removed to obtain particles of a composite material comprising silicon nanoparticles and carbon nanotubes;
the particles of this composite material are contacted with a solution of an amorphous carbon precursor in an organic solvent;
the solvent is removed from the precursor and the precursor is carbonised using a chemical vapour deposition method (CVD).

The amorphous carbon precursor is an organic compound selected from among resins, asphalts, sugars, benzene and naphthalene.

In this document, the silicon nanoparticles and carbon nanotubes are simply mixed statistically without any self-organisation occurring of the silicon nanoparticles around the carbon nanotubes, and on this account the performance of lithium ion rechargeable batteries comprising the material prepared in this document still remains insufficient.

A statistical mixture is defined is an iso-probability that a carbon nanotube (CNT) will be assembled with a silicon particle (P_{CNT-Si}), or a silicon particle will be assembled with a carbon nanotube (P_{Si-CNT}), or a silicon particle will be assembled with a silicon particle (P_{Si-Si}), or a carbon nanotube will be assembled with a carbon nanotube (P_{CNT-CNT}). A statistical mixture corresponds to equal probabilities of assembly i.e. P_{CNT-Si}˜P_{Si-CNT}˜P_{Si-Si}˜P_{CNT-CNT}.

A statistical mixture is not optimal, it does not allow generating of the [symbol] self-assembled [symbol] structure specific to the composite material of the invention. To obtain the [symbol] self-assembled [symbol] structure specific to the material of the invention, it is required that P_{Si-CNT}>>P_{CNT-CNT}>>P_{Si-Si}.

In addition, the amorphous carbon content of the composite material prepared in this document is at the least in the order of 24%, which is very high for use as active negative electrode material in lithium ion batteries.

Finally, the process described in this document also has the disadvantage of using three organic molecules; one as dispersing agent, one as organic solvent and one as precursor of amorphous carbon.

In the light of the foregoing, there is therefore a need for a nanocomposite material comprising carbon nano-objects, more specifically carbon nanotubes or carbon nanofibres, and nano-objects of a material other than carbon namely nanoparticles of silicon or submicron particles of silicon, wherein the nano-objects are distributed in organised manner.

More exactly, there is a need for a composite material wherein the silicon nanoparticles are organised around carbon nanotubes.

There is also a need for said material which, when used as electrochemically active material in a rechargeable battery such as a lithium ion battery, it allows improved performance to be achieved in particular regarding the discharge capacity of these batteries.

There is a further need for said material to be able to withstand volume increases upon charging of the material other than carbon, namely silicon.

Finally, there is a need for a process to prepare said material which is simple, reliable, comprises a limited number of steps and also uses a limited number of organic compounds.

It is the goal of the invention inter alia to meet these needs.

The goal of the present invention in particular is to provide a nanocomposite material comprising carbon nano-objects, more specifically carbon nanotubes or carbon nanofibres, and nano-objects of a material other than carbon namely silicon nanoparticles or submicron silicon particles, which does not has the disadvantages, defects, limitations and shortcomings of prior art nanocomposite materials such as represented in particular by the above-examined documents, and which solves the problems of the materials of the prior art.

It is a further goal of the invention to provide a process to prepare said nanocomposite material which similarly does not have the disadvantages, defects, limitations and shortcomings of the preparation processes of nanocomposite materials of the prior art.

### DISCLOSURE OF THE INVENTION

This goal and others are achieved according to the invention with a composite material comprising nano-objects made of at least one first electron conducting material and nano-objects or submicron objects made of at least one second material differing from the first material; said composite material comprising nanostructures each consisting of the nano-objects made of at least one first electron conducting material marked with a first molecule, the nano-objects or submicron objects made of at least one second material differing from the first material being marked with a second molecule and being self-assembled with and attached to the nano-objects made of at least one first material via (by) specific recognition between the first molecule and the second molecule, said nanostructures being homogeneously distributed in the material, the nano-objects made of at least one first electron conducting material being selected from among carbon nanotubes and carbon nanofibres, and the nano-objects or submicron objects made of at least one second material differing from the first material being selected from among silicon nanoparticles and submicron silicon particles.

The second molecule generally differs from the first molecule.

By «marked» is generally meant that the first molecule, called first marking (labelling) molecule, is attached on the nano-objects made of a first material (generally at least on the outer surface thereof) and that the second molecule, called second marking (labelling) molecule, is attached to the nano-objects made of a second material (generally at least on the outer surface thereof).

It is specified that the phenomenon of specific recognition between molecules, that can also be called phenomenon of molecular recognition, is well known to the man skilled in the art, is the base of biological systems and is used in numerous biotechnological applications.

This recognition e.g. between macromolecules (proteins, nucleic acids) or between macromolecules and organic molecules of smaller size or atoms, takes place in the vast majority of cases via several non-covalent chemical bonds.

The methods of purification, analysis and detection of such macromolecules also use said specific recognitions. For example, the latter involve the pairs (couples): (strept)avidin/biotin; protein A/immunoglobulin; protein G/immunoglobulin; the pairs: antibody/antigen or antibody/epitope such as the poly-His peptide and an antibody specific to this peptide or the C-terminal fragment of the Myc protein and the monoclonal antibody 9E10; the pairs: enzyme/substrate such as the glutathione S-transferase/glutathione pair; or the pairs: nucleotide sequence/complementary nucleotide sequence.

These non-covalent interactions involve ionic bonds, hydrogen bonds, hydrophobic bonds and/or Van der Waals forces.

The first marking molecule and the second marking molecule constitute what can be called a specific recognition pair (couple) between molecules or molecular recognition pair (couple).

The specific recognition pair (couple) between molecules or molecular recognition pair which can be used in the invention is not limited and can be selected in particular from among the specific recognition or molecular recognition pairs already mentioned above ((strept)avidin/biotin etc.).

Preferably, the first molecule is biotin and the second molecule is avidin or streptavidin.

By «homogeneously distributed» is generally meant that the nanostructures are distributed uniformly, regularly, throughout the entire volume of the material, and that their concentration, presence, are substantially the same throughout the volume of the material, in all parts thereof.

Advantageously, the size of each of the nanostructures is at least equal to the size of each of the nano-objects made of at least one first electron conducting material, e.g. to the length of the carbon nanotubes.

Each of the nanostructures can therefore have a size of 1 m to 10 μm.

The content of nano-objects made of at least one first electron conducting material and the content of nano-objects or submicron objects made of at least one second material differing from the first material is 1% to 40% and 60% to 90% by weight respectively.

According to the invention, the nano-objects made of at least one first electron conducting material are specifically selected from among carbon nanotubes and carbon nanofibres; and the nano-objects or submicron objects made of at least one second material differing from the first material are specifically selected from among silicon nanoparticles and submicron silicon particles.

The carbon nanotubes may be selected from among single-wall carbon nanotubes and multi-wall carbon nanotubes such as double-wall carbon nanotubes.

Advantageously, the silicon nanoparticles or submicron silicon particles may be of spherical or spheroidal shape.

It is to be noted that it is more advantageous, as is the case in the invention, to use carbon nanotubes which allows the obtaining of flexible three-dimensional networks (cooked [symbol] spaghetti [symbol] ) whereas metal nanowires give rigid three-dimensional networks ( [symbol] knitting needles [symbol] ).

Advantageously, the ratio of the number of nano-objects or submicron objects made of at least one second material to the number of nano-objects made of at least one first material is 1:100 or less.

Advantageously, the material of the invention is in powder form.

In general, this powder is an extremely aerated, expanded (foamed), scarcely dense powder with high apparent bulk volume, generally higher than 18 litres/Kg of powder.

Advantageously, this powder has a mean particle size, generally corresponding to the mean size of the nanostructures, of between 1 μm and 100 μm e.g. 20 μm, a specific surface area of between 10 m²/g and 50 m²/g, and a density of between 2.014 g/cm³ and 2.225 g/cm³.

The composite material of the invention has never been described or suggested in the prior art.

This material meets the needs indicated above and brings a solution to the problems of prior art materials.

The composite material of the invention has a highly specific structure, with nanostructures each consisting of the nano-objects made of at least one first electron conducting material marked with a first molecule, the nano-objects or submicron objects made of at least one second material differing from the first material being marked with a second molecule, and being self-assembled and attached onto the nano-objects made of at least one first material via (by) a phenomenon of specific recognition (molecular recognition) between the first molecule and the second molecule, and said nanostructures being homogeneously distributed within the material.

Said structure for a nanocomposite material based on carbon nano-objects e.g carbon nanotubes is fully novel.

The very specific structure or organisation of the material according to the invention can be defined as a [symbol] self-assembled [symbol] structure or organisation in which, around and on carbon nano-objects more specifically carbon nanotubes or carbon nanofibres marked with a first molecule, there occurs agglomeration, aggregation, self-assembling, attaching of nano-objects made of a second material namely silicon nanoparticles or submicron silicon particles, these nano-objects made of a second material being marked with a second molecule.

This attachment is ensured according to the invention by a very particular phenomenon, namely a phenomenon of specific recognition between the first molecule and the second molecule respectively marking the nano-objects made of a first material and the nano-objects made of a second material.

The nanocomposite material of the invention differs fundamentally from prior art nanocomposite materials and in particular from silicon/carbon nanocomposite materials, in that in the material of the invention, the nano-objects made of a first material namely CNTs or carbon nanofibres, and the nano-objects made of a second material namely silicon nanoparticles or submicron silicon particles, are organised, self-assembled, whereas in the materials in the prior art the nano-objects are randomly, statistically, distributed.

In none of the prior art materials can such a good dispersion of the nano-objects be obtained with such a regular distribution of said nano-objects.

Moreover, in the material of the invention the organisation of the nano-objects made of a first material namely CNTs or carbon nanofibres, and of the nano-objects made of a second material namely silicon nanoparticles or submicron silicon particles, is a very particular so-called [symbol] self-assembled [symbol] organisation in which the nano-objects made of a second material are self-assembled, attached, around, on the nano-objects made of a first material, e.g. on CNTs which are used as electron conducting backbone. In general, it can be said that the nano-objects made of a first material e.g. CNTs form an electron conducting, three-dimensional network.

In addition, this attaching is ensured, according to the invention, by a very particular phenomenon, namely a phenomenon of specific recognition between the first molecule and the second molecule respectively marking the nano-objects made of a first material and the nano-objects made of a second material. The attachment obtained with this particular phenomenon of molecular recognition of which use is made in the invention is most reliable, uniform and very precise.

The phenomenon of marking a particular material with a molecule is a very particular, random and unpredictable phenomenon dependent on numerous factors and in particular on the shape, type, and on the chemical and physical properties of this material.

The phenomenon of self-assembly via specific recognition of nano-objects made of a first material on nano-objects made of a second material is, similarly, and all the more so, a most particular, unpredictable and random phenomenon also dependent on numerous factors in particular regarding shape, type and chemical and physical properties of the first and second materials.

As already seen above, according to the invention, the nano-objects made of at least one first electron conducting material are specifically selected from among carbon nanotubes and carbon nanofibres; and the nano-objects or submicron objects made of at least one second material differing from the first material are specifically selected from among silicon nanoparticles and submicron silicon particles.

It was therefore fully unexpected and surprising that it is possible to mark (label) not only first specific nano-objects made of a specific material such as carbon and having a specific form namely the form of nanotubes or nanofibres, but also second objects that are just as specific made of a specific material such as silicon and having a specific form namely the form of nanoparticles or of submicron particles.

It was further unexpected and surprising that these first and second objects, each one highly specific, could self-assemble via specific, molecular, recognition to give the nanostructures of the material of the invention.

Compared with materials in which the nano-objects are not organised according to the invention with a self-assembled structure due to molecular recognition, and are distributed statistically, randomly, the material of the invention exhibits improved performance e.g. upon cyclic, rapid charging when used in a lithium ion storage battery.

The structure, organisation of the material of the invention, self-assembled via molecular recognition, unlike materials in which the nano-objects are not similarly organised, allows maintaining of electron conduction and accessibility to the electrolyte, even when the nano-objects or submicron objects made of a second material namely the silicon nanoparticles or submicron silicon particles increase in volume.

The self-assembled structure, organisation of the material of the invention also allows maintaining of the connectivity of the nano-objects or submicron objects made of at least one second material, namely silicon nanoparticles or submicron silicon particles, to the electron conducting three-dimensional network. The organisation of the material of the invention is maintained and is not modified at the time of an individual increase in volume of the nano-objects made of a second material, namely of the silicon nanoparticles or submicron silicon particles.

The invention further concerns a process to prepare the above-described nanocomposite material wherein the following steps are performed:

a) the nano-objects made of at least one first material are marked with a first molecule, by mixing the first molecule and a dispersion in water of the nano-objects made of at least one first material, then the nano-objects made of at least one first material marked with the first molecule are lyophilised (freeze-dried);

b) the nano-objects or submicron objects made of at least one second material are marked with a second molecule by contacting a solution in water of the second molecule with the nano-objects or submicron objects made of at least one second material, then the nano-objects or submicron objects made of at least one second material marked with the second molecule are lyophilised (freeze-dried); then

c) the lyophilised (freeze-dried) nano-objects made of at least one first material marked with the first molecule are contacted under agitation in water with the lyophilised nano-objects or submicron objects made of at least one second material marked with the second molecule; whereby the nanocomposite material is obtained comprising the nano-objects made of at least one first electron conducting material and the nano-objects or submicron objects made of at least one second material differing from the first material, and the nanocomposite material is separated from the water in powder form;

d) optionally, the nanocomposite material is dried, e.g. by lyophilisation (freeze-drying) or by contacting with a supercritical fluid.

The dispersion in water of the nano-objects made of a first material may be obtained in the following manner for example:

The nano-objects made of at least one first material are contacted with water, and the nano-objects made of at least one first material are mixed with the water using the optionally repeated succession of an ultrasonic mixing technique followed by a high speed mixing technique, the mixture of nano-objects made of at least one first material and of water being kept in circulation, e.g. by a pump such as a peristaltic pump, to prevent agglomeration of the nano-objects made of a first material, whereby a dispersion is obtained consisting of water and of the nano-objects made of at least one first material that is preferably maintained in circulation.

Indeed, this dispersion is an unstable mixture when circulation is stopped, for example when the pump, such as a peristaltic pump, is stopped, said pump conveying the mixture of nano-objects and water from the equipment applying the ultrasonic mixing technique, such as an ultrasonic disperser or mixer, to the equipment applying high speed mixing.

The process of the invention comprises a specific sequence of specific steps which has never been described or suggested in the prior art and which allows the preparation of the material of the invention having the specific structure and properties set forth above.

The process of the invention comprises a sequence of simple steps that are easy to implement.

In general, the process of the invention does not use organic solvents since it uses water as sole solvent, or more exactly as dispersion liquid.

It does not use additives, such as organic dispersing agents.

The invention further concerns an ink comprising the composite material of the invention and a carrier. p The carrier generally comprises at least one binder and at least one solvent.

The organic polymer can also be selected from among polytetrafluoroethylene (PTFE), polyvinylidene fluoride (PVDF), PVDF-HFP (propylene hexafluoride) copolymer; carboxymethylcellulose; and elastomers such as CMC-SBR (carboxymethylcellulose-styrene butadiene rubber).

Preferably the binder is a polysaccharide such as an alginate.

Preferably, the solvent is water.

The organic polymer such as a polysaccharide also acts as precursor of amorphous carbon, since it converts to amorphous carbon at the time of carbonisation to prepare an electrode.

Advantageously, the ink may further comprise at least one electron conductor.

This electron conductor may be selected from among graphite, graphene, carbon fibres and the mixtures thereof.

The invention also pertains to an electrode comprising the composite material of the invention as an electrochemically active material.

This electrode inherently has all the advantageous properties related to the composite material contained therein as an electrochemically active material.

This electrode may be a positive electrode or a negative electrode.

The invention further concerns an electrochemical system comprising said electrode.

This electrochemical system may be a non-aqueous electrolyte system such as a rechargeable electrochemical storage battery with non-aqueous electrolyte.

Preferably this electrochemical system is a lithium ion battery.

This electrochemical system such as a lithium ion rechargeable battery inherently has all the advantageous properties related to the electrode contained therein.

### BRIEF DESCRIPTION OF THE DRAWINGS

The invention will be better understood on reading the following detailed description that is non-limiting and given for illustrative purposes, with reference to the appended drawings in which:

FIG. 1 is a schematic cross-sectional side view of the mixing device used to disperse the nano-objects made of at least one first material such as carbon nano-objects e.g. carbon nanotubes.

FIG. 2 is a photograph taken under scanning electron microscope SEM showing the composite material of the invention with the powder of active material, namely silicon nanoparticles, self-assembled via molecular recognition onto carbon nanotubes.

The scale in FIG. 2 is 10 μm.

FIG. 3 is a schematic cross-sectional side view of a battery in the form of a button cell comprising for example a negative electrode to be tested according to the invention.

### DETAILED DESCRIPTION OF PARTICULAR EMBODIMENTS

The following detailed description is rather more given in connection with the process of the invention to prepare a material of the invention and an electrode of the invention, but it also contains teachings which apply to the materials of the invention.

As a preamble to this detailed description, first the definition of some terms used herein is specified.

Viscosities are generally measured at 20° C.

By [symbol] nano-objects [symbol] is generally meant any object alone or linked to a nanostructure having at least one dimension that is 500 nm or less, preferably 300 nm or less, more preferably 200 nm or less, further preferably 100 nm or less and is for example within the range of 1 to 500 nm, preferably 1 to 300 nm, more preferably 1 to 200 nm, further preferably 1 to 100 nm and better still 2 to 10 nm, even 5 to 100 nm.

These nano-objects may be for example nanoparticles, nanowires, nanofibres, nanocrystals or nanotubes.

By [symbol] submicron object [symbol] is generally meant any object having a size, such as the diameter for a spherical or spheroidal object, of less than 1 μm, and is preferably 50 nm to 800 nm, e.g. 310 nm.

By [symbol] nanostructure [symbol] is generally meant an architecture consisting of an assembly of nano-objects and/or of submicron objects which are organised with functional logic and are structured within a space ranging from a cubic nanometre to a cubic micrometre.

By [symbol] polysaccharide [symbol] is generally meant a polymeric organic macromolecule consisting of a chain of monosaccharide units. Said macromolecule may be represented by the chemical formula —[Cₓ(H₂O)_{y}]ₙ—.

As specified below, preferable use according to the invention is given to macromolecules consisting of mannuronic acid (M repeating unit) and guluronic acid (G repeating unit).

The best adapted macromolecular chains for the invention are those which maximise the M repeating units (i.e. the ratio of M repeating units/G repeating units is higher than 60%).

This description generally and more particularly refers to an embodiment in which the composite material prepared using the process of the invention is the positive or negative active electrode material of a lithium ion rechargeable storage battery, but the following description may evidently be extended and adapted, to any application and any use of the composite material prepared with the process of the invention.

In the following description, for reasons of simplicity, a description is more particularly given of a process to prepare a composite material comprising carbon nanotubes and silicon nanoparticles or submicron silicon particles which constitute the active matter or active material of a negative or positive electrode of a lithium ion battery (hereafter called [symbol] active material [symbol] ).

A description will then be given of the preparation of an electrode comprising this composite material. The following description also apples to the preparation of a composite material comprising carbon nanofibres.

At the first step of the process of the invention to prepare a composite material, the molecular marking of the active material (Si) of the nanoparticles or submicron particles of active material (Si) with a second marking molecule is carried out.

For this step, a solution in a solvent of a second marking molecule is added to the nanoparticles or submicron particles of active material (Si).

As seen above, the molecular recognition pair (couple) used in the invention is not limited and may in particular be selected from among the pairs (couples) of specific recognition or molecular recognition already mentioned above.

Preferably the first molecule is biotin, and the second molecule is avidin or streptavidin, and the following description, for practical reasons is rather made with reference to this molecular recognition pair. However the man skilled in the art will understand that this description applies to any pair (couple) of molecular recognition.

The particles of active material namely the silicon particles are generally submicron particles namely having a size, such as a diameter, of less than 1 μm, e.g. from 50 nm to 800 nm, for example of 310 nm.

A spherical shape of the silicon particles is recommended to allow easy insertion of these silicon particles in the entanglement network of carbon nanotubes.

A silicon powder which is particularly suitable for use in the process of the invention is a submicron, spherical silicon powder having particles with a diameter of about 310 nm and is available from the S′tile Company.

The solvent of this solution of nanoparticles or submicron particles consists generally solely of water with the exclusion of any other solvent. In general the water of this solution is deionised water ( [symbol] DI [symbol] water).

Even if the active materials are in general either partly or fully soluble in water, the amount of active material (Si) in the solution is such (this being the solution obtained after addition of the protein solution to the powder) that it is above the solubility limit of the active materials in water, and that a dispersion in water of the nanoparticles or submicron particles of active material (Si) is obtained.

The volume of water required in the solution of protein such as avidin or streptavidin is the interstitial volume of the non-packed active material.

The mass of protein such as avidin or streptavidin placed in the solution is generally equivalent to 0.1% to 1%, for example 1%; of the weight of the volume of interstitial water of the non-packed active material.

The dissolving of the protein such as avidin or streptavidin in water is generally performed under magnetic agitation at ambient temperature, and the solution of water containing the protein such as avidin or streptavidin is then poured into a container containing the powder of nanoparticles or submicron particles of active material (Si). A powder of nanoparticles or submicron particles of active material (Si) is therefore obtained marked with a protein such as avidin or streptavidin.

An homogenizing mixing is carried out before lyophilisation by freezing (freeze-drying) at −80° C. of the powder of active material (Si) marked with protein such as avidin or streptavidin.

In the second step of the process of the invention, molecular marking of the carbon nanotubes with biotin which is a water-soluble vitamin, is performed.

This step could be similarly performed with carbon nanofibres.

For this step, carbon nano-objects namely, here, carbon nanotubes CNTs are dispersed in water. In other words, during this step carbon nano-objects are mixed with water.

The solvent of the dispersion thus prepared consists solely of water with the exclusion of any other solvent. In general, the water of the dispersion is deionised water («DI» water).

Any additive is banned, and no additive of any kind is added to the water since in the dispersion obtained the carbon nanotubes must be in “non-equilibrium” (“out of equilibrium”).

Carbon nanotubes (CNTs) may be single wall carbon nanotubes (SWCNTs) or multi-wall carbon nanotubes (MWCNTs) such as double-wall carbon nanotubes (DWCNTs).

The carbon nanotubes may have a mean length of 1 μm to 10 μm, for example 2 μm and a mean diameter of 5 nm to 50 nm, for example 20 nm.

The concentration of the carbon nano-objects in the dispersion is generally 1 to 5 g/L water, e.g. 2.5 g/L water.

For marking with biotin, it is therefore possible to use a dispersion containing 0.5 g of carbon nanotube in 500 ml of water, i.e. 0.25 g/L water.

Therefore the maximum concentration not to be exceeded for 10 μm tubes is estimated to be 5 mg/ml water.

According to the invention, this dispersion of carbon nano-objects namely carbon nanotubes in water may be obtained by adding the carbon nano-objects to water then subjecting the carbon nano-objects in water to a mixing, dispersing operation, combining two mixing techniques namely an ultrasonic mixing technique followed by a high speed mixing technique.

Preferably, the ultrasounds are generated by a probe placed in a container in which the carbon nanotubes are placed in water.

The ultrasounds generally have an acoustic power density of 1 to 1000 W/cm², e.g. 90 W/cm² and the carbon nano-objects namely the carbon nanotubes are exposed to ultrasound action for a short time of generally 1 to 100 ms, e.g. 20 ms. Such a short duration allows de-agglomeration of the carbon nano-objects without fracturing the carbon nano-objects and thereby prevents the carbon nano-objects from being damaged.

By high speed mixing is generally meant that the carbon nano-objects in water are accelerated and sheared at a shear rate of 500 s⁻¹ to 2000 s⁻¹, and that the velocity of the carbon nano-objects is generally 1 to 5 m/s, e.g. 3 m/s.

Such a speed guarantees optimal de-agglomeration of the carbon nano-objects. Indeed at below 1 m/s and above 5 m/s, there generally occurs agglomeration of the carbon nano-objects.

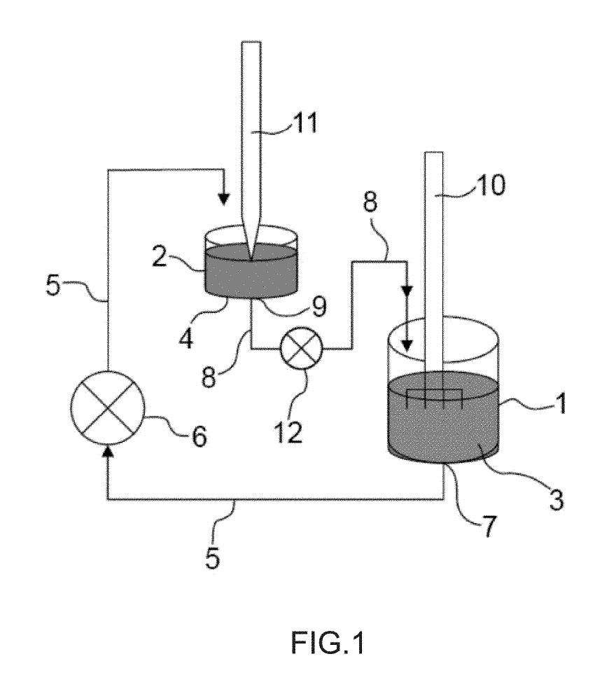

A device that may be used for implementing this step is illustrated in FIG. 1.

This device comprises a high speed mixing vessel 1 and an ultrasonic reactor 2 specific for such use. The high speed mixing vessel 1 and the ultrasonic reactor 2 are in the form of open cylindrical tanks with circular bases 3, 4.

A first pipe 5 on which a first pump is positioned e.g. a peristaltic pump 6, connects an orifice 7 located at the centre of the base 3 of the high speed mixing vessel 1 to the top of the ultrasonic reactor 2.

A second pipe 8 on which a second pump 12 is positioned connects an orifice 9 located at the centre of the base 4 of the ultrasonic reactor 2 to the top of the high speed mixing vessel 1.

The diameter of the second pipe 8 is 6 mm for example.

The flow velocity inside this pipe is estimated at 17 m/min for example, for a flow rate higher than 0.5 L/min.

It is to be noted that instead of using two pumps it is possible to use a single two-way pump e.g. the pump 6 which is then positioned on pipe 5 and pipe 8.

The high speed vessel 1 is equipped with a high speed agitator 10 e.g. of the Ultra Turrax® type.

The mixing technique is an hybridisation of this technique with the ultrasonic technique using a probe.

The ultrasonic probe or horn 11 is placed in the centre of the ultrasonic reactor 2 facing the orifice, outlet 9 located at the centre of the base 4 of the ultrasonic reactor 2.

To prepare the dispersion of carbon nano-objects, first water is placed in the mixing vessel without the high speed agitator being actuated, and then the carbon nano-objects namely the carbon nanotubes are added to the water. Or else the carbon nano-object may first be placed in the mixing vessel without the high speed agitator being actuated, and then the water is added thereto.

A mixture of carbon nano-objects and water is thus formed.

Or else, the carbon nano-objects are pre-dispersed, previously mixed, and this pre-dispersion, this mixture is placed in the vessel 1.

The mixture of water and carbon nano-objects consists for example of 1.25 g carbon nano-objects, namely CNTs, in 500 ml of deionised water, i.e. the concentration of carbon nano-objects in the mixture is 2.5 mg/ml.

The mixture of water and carbon nano-objects, namely carbon nanotubes, is conveyed via pipe 5 under the action of pump 6 and arrives in the ultrasonic reactor 2.

In the ultrasonic reactor the carbon nano-objects undergo exposure to ultrasound emitted by the probe; for example they are subjected to ultrasound at a frequency of 20 kHz and a power of 250 W for a short time e.g. about 20 ms, this corresponding to about 400 pulses.

This short exposure time to ultrasound ensures that the carbon nano-objects namely CNTs are not damaged and allows de-agglomeration thereof without fracturing thereof since the energy involved generally does not exceed 5 Joules.

The mixture of water and carbon nano-objects exposed to ultrasound is then set in movement by the peristaltic pump 12 to acquire sufficient linear velocity so that the carbon nano-objects do not re-agglomerate in the pipe 8 after having passed through reactor 2 and exposure to ultrasound. This linear velocity is at least 10 m/min, and for example it may be 17 m/min.

On leaving the ultrasonic reactor 2 the carbon nano-objects arrive via pipe 8 in the high speed vessel 1 where they are accelerated and sheared at a shear rate of 1175 s⁻¹ for example.

Here again, the carbon nano-objects locally reach a velocity of generally 3 m/s which guarantees optimal de-agglomeration. At below 1 m/s and above 5 m/s, agglomeration of the nano-objects, namely of the CNTs occurs.

The preparation of the aqueous dispersion by combining the ultrasonic mixing technique and high speed mixing technique generally lasts 10 to 60 minutes e.g. 30 minutes.

The dispersion is characterized by the presence of agglomerates having a size of between 5 μm and 80 μm.

There are therefore still agglomerates of CNTs contained in the prepared dispersion, which is surprising. The CNTs are not entirely networked, however interactions, connections exist between these CNTs and they surprisingly form agglomerates wherein they are linked.

In other words, the water expands the CNT network but interactions between the CNTs are effectively present.

The purpose of placing the carbon nanotubes in dispersion is not to obtain a perfect dispersion, since in this case the connections between the tubes no longer exist, and this give a statistical state of the dispersion of CNTs.

As specified above, the dispersion obtained at the end of the first step does not contain any solvent other than water and does not contain any additive e.g. of dispersing agent type such as Sodium Dodecyl Sulfate (SDS), Dodecyl Benzene Sulfate (SDBS), Lithium Dodecyl Sulfate (LDS), Trimethyl ammonium Bromide (TTAB), Cetyltrimethyl ammonium bromide (CTAB), Sodium Desoxycholate (SC), Taurodeoxycholate (DOC), Igeal Co890®, Triton X-100® (C₈H₁₇C₆H₄(OC₂H₄)₉₋₁₀OH), and Tween® 20 and 80.

The dispersion obtained consists therefore of carbon nanotubes and water, generally deionised water.

This dispersion is a «non-equilibrium» (“out of equilibrium”) dispersion solely comprising a non-stable phase of CNTs and water, it must therefore be kept under agitation, and agitation must not be discontinued.

In general, throughout all transfers, the dispersion must be always in movement, must always have kinetic energy, and must have a sufficient linear velocity as already specified above.

Biotin is then added in the proportion of 0.1% to 1% by weight to the dispersion of carbon nanotubes under magnetic agitation at ambient temperature, so that the vitamin such as biotin becomes attached to the carbon nanotubes due to π interactions of the graphene sheets.

The amount of biotin added is generally 1 to 10 mg/L of carbon nanotubes dispersion. Therefore 10 mg of biotin may be added per 1000 mL of carbon nanotubes dispersion.

The dispersion is then lyophilised (freeze-dried) i.e. it is successively frozen, solidified and sublimated.

For this purpose, drops of the dispersion are formed generally having a diameter of 0.5 to 2 mm, e.g. 1 mm, using a «pilling» system for example, and these drops are directly dropped into liquid nitrogen, whereby, through rapid freezing, frozen macro-objects or capsules are obtained, preferably of spherical shape, such as ice beads, and having a size e.g. a diameter for example of 0.5 mm to 2 mm, for example of 1 mm.

These frozen macro-objects or capsules preferably of spherical shape, such as ice beads, contain expanded carbon nanotubes marked with biotin.

This solidification, freezing actually constitutes the first part of the lyophilising (freeze-drying) treatment.

This solidification, freezing of the dispersion to yield macro-objects is followed by a sublimation step which constitutes the second part of the lyophilising (freeze-drying) treatment.

During this sublimation step, under the effect of vacuum, the frozen solvent, namely the ice, inside the macro-objects or capsules is removed and the enzyme such as biotin attaches to the surface of the carbon nanotubes.

Lyophilisation (freeze-drying) is generally performed under a high vacuum, namely under a pressure not exceeding 5.10⁻³ mbar, e.g. a pressure of 10⁻³ to 10⁻⁷ mbar and at a temperature not exceeding −20° C., e.g. a temperature of −80° C.

The duration of lyophilisation is dependent on the equipment used and may last for example, 1 h to 12 h per litre of dispersion.

Then, in a third step of the process of the invention, the powder of marked active material (Si) is assembled on the marked carbon nanotubes via molecular recognition between the biotin and avidin or streptavidin.

First, a dispersion is prepared consisting of marked carbon nanotubes and water.

For this purpose, the lyophilised (freeze-dried) marked (labelled) carbon nanotubes previously prepared are added to a certain volume of water e.g. 500 mL of water under magnetic agitation, to obtain a dispersion of marked carbon nanotubes.

The carbon nanotubes concentration of this dispersion is generally 1 to 2.5 mg/L.

To this dispersion of marked carbon nanotubes, still under magnetic agitation, is added the powder of nanoparticles or of submicron particles of marked active material (Si).

The amount of nanoparticles or submicron particles of active material (silicon) is such that the dispersion of carbon nanotubes and nanoparticles or submicron particles of active material (silicon) obtained generally contains 5 to 15 g, e.g. 8 g of nanoparticles or submicron particles of active material (silicon)/L of dispersion.

Indeed, 15 g of silicon particles/L of dispersion, self-assembling is generally no longer possible since the number of silicon particles is too high compared to the number of carbon nanotubes. The same applies below 5 g of silicon particles/L of dispersion.

The weight ratio of the number of nanoparticles or submicron particles of marked active material (silicon): number of carbon nanotubes is generally 60:1 to 99:1 e.g. 99:1.

The nanoparticles or submicron particles of marked active material (silicon) are generally added at a constant rate generally at a rate of 10 to 500 mg/min, e.g. at the rate of 300 mg/min. Therefore if 9 g of active material, namely of silicon, are added, the addition time will generally be 30 minutes.

The duration of this step during which the conditions set forth above are maintained, namely inter alia the addition of particles of active material (silicon) at constant rate, the shear rate and the high fluid velocity is generally 16 to 60 minutes e.g. 30 minutes.

At the end of this step, the self-assembled composite material according to the invention is therefore obtained which is then separated from the water of the dispersion in the form of a powder and optionally dried. For example, the composite material may be lyophilised under suitable conditions, or simply dried, generally by contacting with a supercritical fluid such as supercritical CO₂.

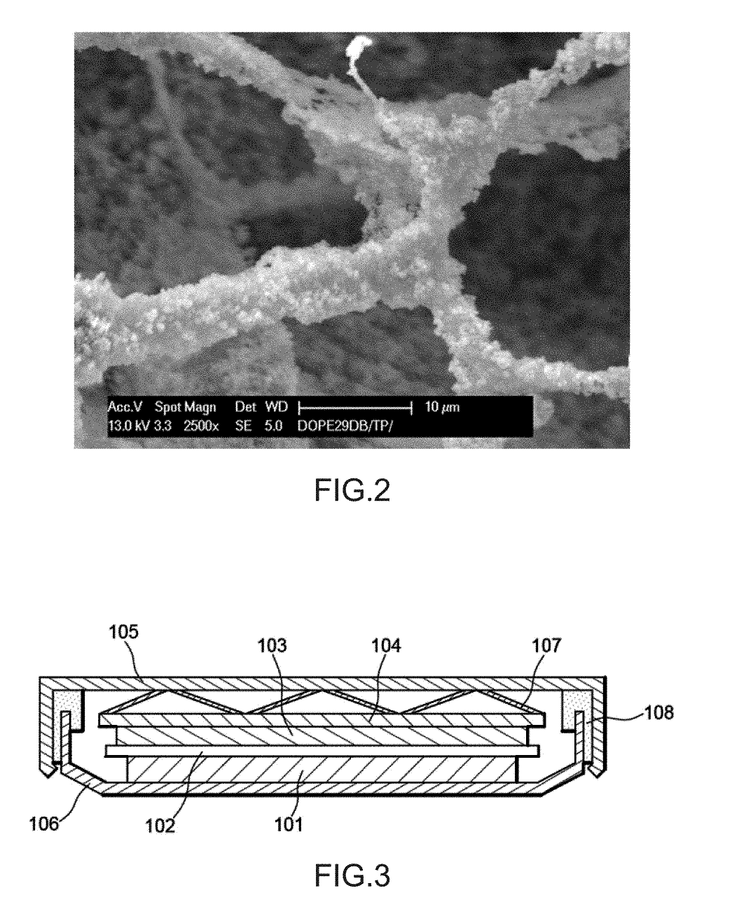

The SEM image of FIG. 2 is a typical image of a self-assembly of silicon nanoparticles on carbon nanotubes by molecular recognition.

The powder of self-assembled composite material thus prepared according to the invention, more simply called self-assembled powder after optional lyophilisation, is ready for any subsequent use, for example to produce ink and does not require milling which would break up all organisation present in the powder.

The particle size of the self-assembled powder is generally between 1 μm and 100 μm, its specific surface area is generally between 10 m²/g and 50 m²/g, and its density is generally between 2.014 g/cm³ and 2.225 g/cm³. The expression «expanded powder» may be used.

The self-assembled powder may be mixed e.g. by mere mechanical action with all kinds of materials.

This mechanical action may comprise one or more operations for example, only an extrusion may be performed; or a else mere mechanical mixing may be performed; or else mere mechanical mixing optionally followed by drying of the mixture may be performed.

The specific organisation according to the invention, the self-assembling, of carbon nanotubes or nanofibres and of nanoparticles or submicron particles of active material (Si), such as CNTs and silicon nanoparticles, is preserved after this mechanical action.

For example, if it is desired to prepare an ink or paste containing the self-assembled composite material of the invention, said material is mixed with materials constituting the vehicle of this ink or paste.

By [symbol] vehicle of an ink or paste [symbol] is generally meant the components, ingredients needed to impart the desired properties to this ink or paste and to the marking obtained with this ink or paste.

The vehicle of the ink or paste generally comprises a binder and a solvent.

The vehicle may further comprise at least one electron conductor differing from the self-assembled, composite material according to the invention.

There is no limitation as to the ink in which the composite material according to the invention may be incorporated; in particular, there is no limitation regarding the vehicle, binder and solvent with which the material of the invention may be mixed to prepare an ink or paste.

The ink may be a water-based ink i.e. the solvent of which mainly (in majority) comprises water or consists of water; an organic-based ink i.e. the solvent of which mainly (in majority) comprises one or more organic solvents or consists of one or more organic solvents e.g. a so-called fat-based ink for which the solvent consists of one or more siccative oils; a silica or carbon-sol-gel based ink.

The binder may be selected from among organic polymers such as photo-cross-linkable polymers e.g. acrylic polymers, heliographic resins, photolithographic resins, cross-linkable thermosetting resins such as epoxides, natural polymers such as polysaccharides e.g. alginates.

Preferably, the solvent is water, and the binder is a polysaccharide such as an alginate.

Since the organisation, self-assembling of the nanopowders of the composite material according to the invention take place upstream of ink manufacture, it becomes possible to use any binder in particular any organic binder as a binder for this ink and the electrode prepared therefrom.

This ink or paste is generally intended for the preparation of an electrode via coating, printing, depositing, by means of printing a device, of said ink or paste onto a current collector.

The composite material according to the invention can be used as electrochemically active electrode material in any electrochemical system.

More specifically, according to one embodiment of the process to prepare an electrode according to the invention, the composite material according to the invention may be used in particular as positive or negative electrochemically active electrode material in any electrochemical system, in particular in any electrochemical system with a non-aqueous electrolyte.

This positive or negative electrode, aside from the electrochemically active negative or positive electrode material such as defined above, comprises a binder which is generally an organic polymer, optionally one or more electron conducting additive(s) and a current collector.

Some organic polymers which can be used for the binder have already been cited above.

The organic polymer may also be selected from among polytetrafluoroethylene (PTFE), poly(vinylidene fluoride) (PVDF), the copolymer PVDF-HFP (propylene hexafluoride); carboxymethylcellulose; and elastomers such as CMC-SBR (carboxymethylcellulose-styrene butadiene rubber).

Preferably, the binder is a polysaccharide such as an alginate.

The optional electron conducting additive may be selected from among metal particles such as Ag particles, graphite, graphene, carbon black, carbon fibres, carbon nanowires, carbon nanotubes and electron conducting polymers, and the mixtures thereof.

Indeed, graphene and carbon fibres can fulfil exactly the same function as graphite in ink.

Only the large-scale organisation will be different depending on the type of envisaged electron conductor such as carbon fibres or micrometric graphite.

The current collector is generally in the form of a copper, nickel or aluminium foil or mesh, grid.

The electrode generally comprises 70% to 94% by weight of electrochemically active material, 1% to 20% by weight preferably 1% to 10% by weight of binder, and optionally 1% to 15% by weight of electron conducting additive(s).

Said electrode may be conventionally prepared as according to a first embodiment of the process to prepare an electrode according to the invention, by forming a suspension, paste or ink, as described above, with the composite material according to the invention, the binder which is then preferably a polysaccharide, optionally the electron conducting additive(s), and a solvent, by depositing, coating or printing this suspension, paste or ink on a current collector, by drying the deposited ink, paste or suspension, by calendering, pressing the dried deposited ink or paste and the current collector, and finally by heat treating the electrode to carbonise the polysaccharide such as an alginate, and to convert it to amorphous carbon.

To form a suspension, paste or ink, the material according to the invention, generally in the form of an expanded self-assembled powder such as described above is incorporated in the ink vehicle i.e. a mixture of the binder, solvent and of the optional conducting additives

Preferably, the solvent and binder are in the form of an aqueous polysaccharide gel such as an alginate hydrogel.

There is no limitation as to the polysaccharide macromolecule and all molecules belonging to the family of polysaccharides can be used in the process of the invention. They may be natural or synthetic polysaccharides.

The polysaccharide macromolecule may be selected from among pectins, alginates, alginic acid and carrageenans.

By [symbol] alginates” is meant both alginic acid and the salts and derivatives thereof, such as sodium alginate. Alginates and in particular sodium alginate are extracted from various Phaeophyceae rown algae, chiefly Laminaria such as Laminaria hyperborea; and Macrocystis such as Macrocystis pyrifera. Sodium alginate is the most commonly marketed form of alginic acid.

Alginic acid is a natural polymer having the molecular formula (C₆H₇NaO₆)ₙ consisting of two monosaccharide units: D-mannuronic acid (M) and L-guluronic acid (G). The number of alginate base units is generally about 200. The proportion of mannuronic acid and guluronic acid varies from one alga species to another and the number of M units to the number of G units may range from 0.5 to 1.5, preferably from 1 to 1.5.

Alginates are linear, non-branched polymers and are generally not random copolymers; however depending on the alga from which they are derived they consist of sequences of similar or alternate units, namely sequences GGGGGGGG, MMMMMMMM, or GMGMGMGM.

For example, the M/G ratio of the alginate derived from Macrocystis pyrifera is about 1.6 whilst the M/G ratio of the alginate derived from Laminaria hyperborea is about 0.45.

Among the polysaccharide alginates derived from Laminaria hyperborea, mention may be made of Satialgine SG 500; among the polysaccharide alginates derived from Macrocystiis pyrifera of different molecule lengths mention can be made of the polysaccharides called A7128, A2033 and A2158 which are generics of alginic acids.

The polysaccharide macromolecule used in the invention generally has a molecular weight of 80000 g/mol to 500000 g/mol, preferably 80000 g/mol to 450000 g/mol.

The incorporation of the composite material of the invention into this mixture is preferably performed using a mixing technique without grinding, in a mixer, e.g. of the planetary mixer type which does not generate any grinding and uses very low energy namely generally lower than 100 Joules/revolution, to preserve the self-assembling of the carbon nanotubes with the nanoparticles or submicron particles of active material, namely silicon, which is maintained at 60 J/rev.

Said mixing equipment prevents the forming of lumps and allows ink fineness to be maintained below 10 μm.

It is therefore possible with this technique and this equipment to obtain close mixing of the self-assembled powder of carbon nanotubes and nanoparticles or submicron particles of active material, namely silicon, with the vehicle such as an alginate hydrogel, by adjusting viscosity with water to reach for example a value of 1 Pa·s at a shear rate of 1 s⁻¹ and particle size fineness, smaller than 10 μm.

For example, the alginate gel may first be placed into the planetary mixer at a concentration generally of 6% to 10% by weight e.g. 8% by weight, followed by the self-assembled powder of carbon nanotubes and nanoparticles or submicron particles of active material, namely silicon, optionally with its electron conductor.

The speed of rotation is slow e.g. approximately 100 rpm and the pressure is 2 bar for example in the plate.

The dry extract composition of the ink is 60% to 90% by weight e.g. 85% by weight of self-assembled active material at 0.5% to 5% by weight e.g. 1% by weight of carbon nanotubes (electron conducting additive), bound to 5% to 20% by weight of alginate e.g. 14% by weight.

The ink, paste or suspension may be applied using any suitable method such as coating, laminating, photo-engraving, flexography, offset.

The deposited, applied, thickness of ink, paste or suspension is generally 50 to 300 μm, e.g. 100 μm.

The deposited ink, paste or suspension is generally dried at ambient temperature, namely 15° C. to 30° C., preferably 20° C.

The heat treatment of the electrode to carbonise the polysaccharide of the binder, such as an alginate, and to convert the same to amorphous carbon is generally conducted at a temperature of 400° C. to 650° C., e.g. 600° C., for a time of 15 to 60 minutes, e.g. 30 minutes under an inert gas flushing such as argon or under a slightly reducing gas flushing such as a mixture of an inert gas such as argon and of a reducing gas such as hydrogen, for example an argon and hydrogen mixture (for example at 2% by volume of hydrogen).

Beforehand, 2 primary (rough) vacuum cycles are conducted to remove oxygen and water from the material.

Weight loss generally does not exceed 30% which is a low value guaranteeing good cohesion of the electrode and good adhesion to the current collector e.g. the copper foil forming this current collector.

These electrodes are then cut into pellets and these pellets may be then treated with an hydrogen plasma to deoxidise the silicon of the composite material and to etch the amorphous carbon to improve the accessibility of the electrolyte to the surfaces of the silicon nanoparticles or silicon submicron particles.

The electrochemical system in which the electrode according to the invention is used may, in particular, be a rechargeable electrochemical storage battery (accumulator) with a non-aqueous electrolyte such as a lithium storage battery or battery, and more particularly a lithium ion storage battery which, aside from the positive or negative electrode such as defined above comprising as an electrochemically active material the composite material prepared according to the invention in which the polysaccharide of the binder has been carbonised and converted to amorphous carbon, also comprises a negative or positive electrode which does not comprise the composite material according to the invention, and a non-aqueous electrolyte.

The negative or positive electrode which does not comprise as an electrochemically active material the composite material according to the invention in which the polysaccharide has been carbonised, comprises an electrochemically active material differing from the composite material of the invention, a binder, optionally one or more electron conducting additive(s), and a current collector.

The binder and the optional electron additive(s) have already been described in the foregoing.

The electrochemically active material of the negative or positive electrode which does not, as electrochemically active material, comprise the composite material according to the invention in which the polysaccharide has been carbonised may be selected from among all materials known to the man skilled in the art.

For example, when the composite material of the invention in which the polysaccharide has been carbonised is the electrochemically active material of the negative electrode, then the electrochemically active material of the positive electrode may be selected from among metal lithium and any material known to the man skilled in the art in this technical field.

When the electrochemically active material of the positive electrode is formed by the material according to the invention in which the polysaccharide has been carbonised, the electrochemically active material of the negative electrode may be in any material known to and adaptable to the man skilled in the art.

The electrolyte may be solid or liquid.

If the electrolyte is liquid, it consists for example of a solution of at least one conducting salt such as a lithium salt in an organic solvent and/or an ionic liquid.

If the electrolyte is solid, it comprises a polymer material and a lithium salt.

The lithium salt may be selected for example from among LiAsF₆, LiClO₄, LiBF₄, LiPF₆, LiBOB, LiODBF, LiB(C₆H₅), LiCF₃SO₃, LiN(CF₃SO₂)₂ (LiTFSI), LiC(CF₃SO₂)₃ (LiTFSM).

The organic solvent is preferably a solvent compatible with the constituents of the electrodes, relatively scarcely volatile, aprotic and relatively polar. Ethers, esters and mixtures thereof for example may be cited.

Ethers are particularly selected from among linear carbonates such as a dimethyl carbonate (DMC), diethyl carbonate (DEC), ethylmethyl carbonate (EMC), dipropyl carbonate (DPC), cyclic carbonates such as propylene carbonate (PC), ethylene carbonate (EC), and butylene carbonate; alkyl esters such as formiates, acetates, propionates and butyrates; gamma-butyrolactone, triglyme, tetraglyme, lactone, dimethylsulfoxide, dioxolane, sulfolane and the mixtures thereof. The solvents are preferably mixtures including EC/DMC, EC/DEC, EC/DPC and EC/DMC.

The rechargeable battery may in particular be in the form of a button cell.

The different parts of a button cell made of 316 L stainless steel are described in FIG. 3.

These parts are the following:
upper 105 and lower 106 parts of the stainless steel casing,
polypropylene seal 108,
shims (holds) 104 made of stainless steel used for example both to cut lithium metal and subsequently to ensure good contact between the current collectors and the external parts of the battery,
a spring 107, ensuring contact between all parts,
a microporous separator 102 impregnated with electrolyte,
electrodes 101, 103.

The invention will now be described with reference to the examples given as non-limiting illustrations.

### EXAMPLES.

### Example 1

In this example, a composite material silicon nanoparticles/carbon nanotubes according to the invention is prepared, using the process of the invention, such as described in the foregoing.

The first manufacturing step is the molecular marking of the silicon nanoparticles.

The amount of silicon nanoparticles is such that the solution (namely the solution containing the active material, DI water and avidin or streptavidin protein) is above the solubility limit.

To mark these silicon nanoparticles, avidin or streptavidin is used. The volume of water required is the interstitial volume of the non-packed silicon nanoparticles.

The mass of avidin or streptavidin added to the solution is equivalent to 1% by weight of the interstitial water volume.

Dissolving is carried out under magnetic agitation at ambient temperature and the water solution containing avidin (or streptavidin) is then poured into the container containing the powder.

Homogenisation by mixing is carried out before freezing at −80° C. and lyophilisation of the powders of marked active materials.

The second manufacturing step is the molecular marking of the carbon nanotubes with biotin, a water-soluble vitamin.

The powdered carbon nanotubes are placed in solution at a concentration of less than 5 mg/ml water.

For marking with biotin, a solution, dispersion is used containing 0.5 g of carbon nanotube in 500 mL of water.

The carbon nanotubes are dispersed by applying mixed agitation using ultrasound and high speed shear (of Ultra-Turrax® type). The installation allowing said mixed agitation is illustrated in FIG. 1.

10 mg of biotin are added in the solutions of CNTs under magnetic agitation at ambient temperature so that the biotin becomes attached to the carbon nanotubes via π interaction of graphene sheets.

The solution is then passed through a «pilling» system to form droplets about 1 mm in diameter which fall directly into a container of liquid nitrogen for rapid freezing.

The ice beads containing the expanded carbon nanotubes marked with biotin are then lyophilised for attaching of the biotin onto the surfaces of the carbon nanotubes.

The third step is the assembly step of the powder of marked silicon nanoparticles on the marked carbon nanotubes via molecular recognition between avidin and biotin.

For this step, the marked nanotubes are poured into 500 ml of water under magnetic agitation and the marked active materials are added to the water.

The weight proportion of silicon nanoparticles/CNTs is 99:1.

On completion of the third step, the composite material is separated from the water, and the water is then removed using any suitable means.

The SEM image in FIG. 2 shows a typical image of a self-assembly silicon nanoparticles on carbon nanotubes via molecular recognition.

### Example 2

In this example an ink is prepared according to the invention using a described planetary mixer.

First an 8% alginate gel is placed into the planetary mixer and then the self-assembled active material prepared in Example 1 with its electron conductor i.e. carbon black or carbon fibres of VGCF type.

The rotation speed is slow, approximately 100 rpm and the pressure is 2 bar in the plate.

The dry extract composition of the ink is 85% self-assembled active materials at 1% CNTs bound to 14% alginate.

1. A composite material, comprising:
nano-objects made of at least one first electron conducting material; and
nano-objects or submicron objects made of at least one second material differing from the first material,
wherein
the composite material comprises nanostructures each comprising the nano-objects made of at least one first electron conducting material marked with a first molecule,
the nano-objects or submicron objects are made of at least one second material differing from the first material being marked with a second molecule and being self-assembled and attached onto the nano-objects made of at least one first material by specific recognition between the first molecule and the second molecule, said nanostructures being homogeneously distributed in the material,
the nano-objects made of at least one first electron conducting material are selected from the group consisting of carbon nanotubes and carbon fibres, and
the nano-objects or submicron objects are made of at least one second material differing from the first material and selected from the group consisting of silicon nanoparticles and submicron silicon particles.

2. The material according to claim 1, wherein the first marking molecule and the second marking molecule constitute a specific recognition pair between molecules, selected from among the pairs: (strept)avidin/biotin; protein A/immunoglobulin; protein G/immunoglobulin; antibody/antigen or antibody/epitope pairs; enzyme/substrate pairs; and nucleotide sequence/complementary nucleotide sequence pairs.

3. The material according to claim 1, wherein the size of each of the nanostructures is at least equal to the size of each of the nano-objects made of at least one first electron conducting material.

4. The material according to claim 1, wherein the carbon nanotubes are selected from the group consisting of single-wall carbon nanotubes, and multi-wall carbon nanotubes.

5. The material according to claim 1, wherein the silicon nanoparticles or submicron silicon particles are of spherical or spheroidal shape.

6. The material according to claim 1, wherein a ratio of the number of nano-objects or submicron objects made of at least one second material to the number of nano-objects made of at least one first material is 1:100 or less.

7. The material according to claim 1, which is in the form of a powder.

8. The material according to claim 7, wherein the powder has a mean particle size of between 1 μm and 100 μm, a specific surface area of between 10 m²/g and 50 m²/g, and a density of between 2.014 g/cm³ and 2.225 g/cm³.

9. A process for preparing the composite material of claim 1, the process comprising:
a) marking the nano-objects made of at least one first material with a first molecule, by mixing the first molecule and a dispersion in water of the nano-objects made of at least one first material, then the nano-objects made of at least one first material marked with the first molecule are freeze-dried;
b) marking the nano-objects or submicron objects made of at least one second material with a second molecule by contacting a solution in water of the second molecule with the nano-objects or submicron objects made of at least one second material, then the nano-objects or submicron objects made of at least one second material marked with the second molecule are freeze-dried; then
c) the lyophilised (freeze-dried) nano-objects made of at least one first material marked with the first molecule are contacted under agitation in water with the lyophilised nano-objects or submicron objects made of at least one second material marked with the second molecule; whereby the nanocomposite material is obtained comprising the nano-objects made of at least one first electron conducting material and the nano-objects or submicron objects made of at least one second material differing from the first material, and the nanocomposite material is separated from the water in powder form;
d) optionally, the nanocomposite material is dried.

10. An ink, comprising the composite material according to claim 1 and a vehicle.

11. The ink according to claim 10, further comprising at least one electron conductor.

12. An electrode, comprising as electrochemically active material the composite material according to claim 1.

13. The electrode according to claim 12, which is a negative electrode.

14. An electrochemical system, comprising an electrode according to claim 12.

15. The electrochemical system according to claim 14, which is a system with non-aqueous electrolyte.

16. The electrochemical system according to claim 15, which is a lithium ion storage battery.
